(19) United States
(12) Patent Application Publication
(10) Pub. No.: US 2002/0090730 A1
(43) Pub. Date: Jul. 11, 2002

(54) Method for treating objects

(75) Inventors: Ralf Eckert, Dossenheim (DE); Robert Gropp, Schifferstadt (DE)

Correspondence Address: George L. Snyder, Jr., Hodgson Russ LLP, Suite 2000, One M&T Plaza, Buffalo, NY, 14203-2391, US

(73) Assignee: Leica Microsystems Nussloch GmbH, Nussloch (DE)

(21) Appl. No.: 10/004,138

(22) Filed: Oct. 23, 2001

(30) Foreign Application Priority Data
Oct. 24, 2000 (DE) 100 52 833.3

(51) Int. Cl. G01N 35/00

(52) U.S. Cl. 436/48; 422/65; 422/67

(57) ABSTRACT

A method for treating objects, in particular cytological or histological specimens, for example in an automatic stainer, the objects being delivered, preferably on object carriers and in object carrier magazines, by means of a transport device to various processing stations, inserted therein, and treated in accordance with a selectable treatment program, is characterized by automatic monitoring of the processing stations, in particular of the reagents, definable parameters being taken into consideration in the monitoring.

### CROSS REFERENCE TO RELATED APPLICATIONS

This invention claims priority of the German patent application 100 52 833.3 filed Oct. 24, 2000 which is incorporated by reference herein.

### FIELD OF THE INVENTION

The present invention concerns a method for treating objects, in particular cytological or histological specimens, for example in an automatic stainer, the objects being delivered, preferably on object carriers and in object carrier magazines, by means of a transport device to various processing stations, inserted therein, and treated in accordance with a selectable or a definable or programmable treatment program.

### BACKGROUND OF THE INVENTION

The reader is referred, merely by way of example, to EP 0 849 582 A1. This document discloses a generic method for treating objects, in particular cytological or histological specimens. In it, cytological or histological specimens are conveyed, by means of an object carrier or basket and optionally in magazines, to the differently operating treatment stations of an automatic stainer, the stainer comprising multiple processing stations having different reagents.

The generic method known from EP 0 849 582 A1 makes no arrangements for checking the quality and quantity of the reagents necessary for treatment, so that a reproducible staining result with uniform quality is always uncertain, especially over longer treatment times.

### SUMMARY OF THE INVENTION

It is thus the object of the present invention to configure and further develop a method for treating objects, in particular cytological or histological specimens, in such a way that reproducible staining results of uniform quality can be attained even over longer treatment time periods.

### BRIEF DESCRIPTION OF THE DRAWING

In the drawing:

FIG. 1 shows a graphical display in accordance with an exemplary embodiment of the present invention.

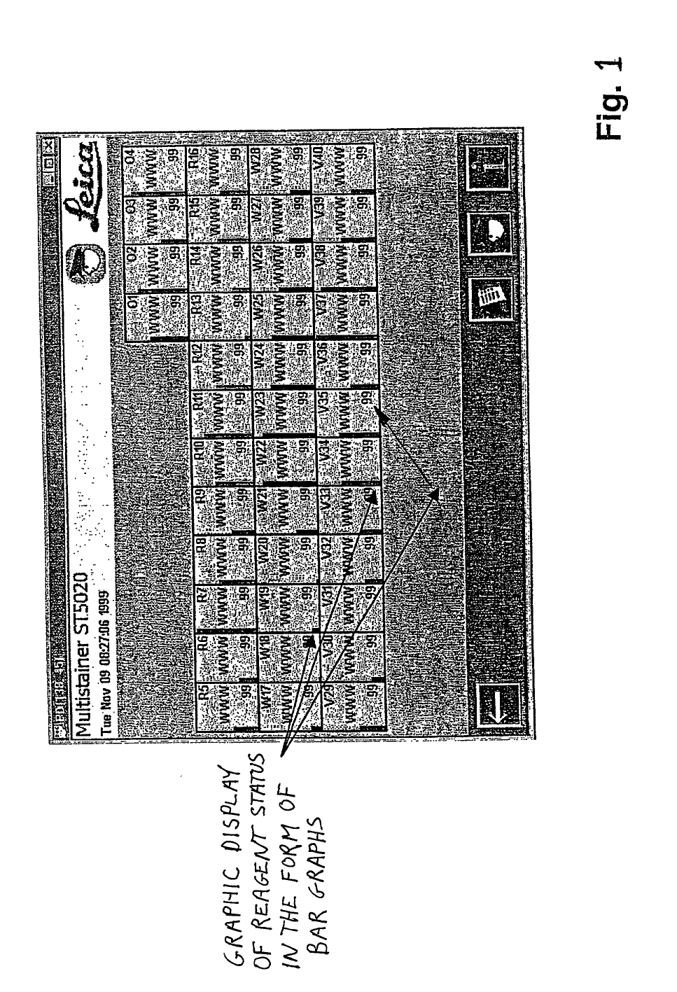

### DETAILED DESCRIPTION OF THE INVENTION

The aforesaid object is achieved by improvement of the generic method for treating objects, in particular cytological and histological specimens. The generic method is improved by automatic monitoring of the processing stations, in particular of the reagents, definable parameters being taken into consideration in the monitoring.

What has been recognized according to the present invention is that reproducible treatment results of identical quality are achieved if automatic monitoring of the processing stations, in particular of the reagents, takes place. For that purpose, definable parameters are taken into consideration in the monitoring, or such definable parameters are incorporated into the monitoring, in particular in the context of the electronic data processing necessary for the purpose.

Concretely, the type or reagent designation of the reagents present in the processing stations could be defined by the user as a parameter, and allocated to the respective processing station. This might concern, for example, 80% alcohol. Any aqueous solutions, solvents, staining agents, etc. might also be involved. The same is true of the working life limits for the reagents as a further parameter, which are also defined by the user and allocated to the respective processing stations.

For definition of the working life limit of the reagents, an upper and a lower limit value can be defined, again as a parameter; these limit values, as well, can be allocated to the respective processing stations. The upper and lower limit values can be true (i.e. defined) limit values or warning thresholds; the limit value can be defined on the one hand, for example, by an indication of the present consumption of a reagent—i.e. how many baskets with objects or object carriers have already been processed—and on the other hand (alternatively) by the predicted working life—i.e. how many baskets can still be processed.

It is also possible to select working life limits and corresponding limit values from a library that is predefined and/or can be added to by the user; such libraries can be made available by the manufacturer of the reagents. Any desired addition to this library is conceivable, in particular with regard to mixtures prepared by users themselves. In this context, let it be emphasized once again that limit values can be defined or not. The limit values can moreover be modified by the user. In addition, a library of limit values can be defined and (optionally) expanded or reduced (as necessary) by the user. As already indicated previously, the maximum number of baskets that a reagent station can process after being refilled can serve as the concrete working life parameter. Lastly, both the number of baskets already processed and the number of baskets yet to be processed are suitable as parameters.

The absolute working life of the reagents can be defined, also as a parameter, in terms of days since the last reagent change, and once again can be allocated to the respective processing stations. After a change of reagents, the number of working processes that has taken place in the respective processing station could be counted, and from that the working life in days could be calculated. This calculated parameter is also allocated to the respective processing stations.

Monitoring of the reagents could encompass, using corresponding detectors, the physical composition and above all the fill level or volume of the reagents present in the respective processing station.

Especially with regard to simple handling of the apparatus using the method, it is very particularly advantageous if the parameters on which the monitoring is based, and optionally data detected and/or calculated therefrom, are displayed on a display, preferably upon a request by the user. The display can be a conventional monitor, in particularly advantageous fashion a so-called touch panel. In this context, the user could have displayed to him or her, preferably in graphical form as a status overview of the individual processing stations, the parameters on which the monitoring is based and optionally data detected and/or calculated therefrom, in particular with regard to the freshness of the reagents; a matrix or a corresponding diagram that symbolizes the processing stations, preferably in their concrete arrangement, can be used for the graphical depiction. Lastly, the arrangement of the processing stations could be represented exactly on the monitor, so that ultimately an analog depiction of the processing situation is available to the user.

The fill level and/or working life of the reagents could be indicated in analog fashion, preferably by way of a bar or the like associated with the processing station, the bar being reduced as the fill level and/or working life diminishes until the working life limit is exceeded. The bar could shrink to zero or to a residual value; advantageously, an adjustment or calibration of the display could be implemented.

In addition to the working life, the reagent consumption indication can also be depicted in analog fashion.

It is also possible for further parameters and data relevant to processing, for example detectable operating states of the entire unit, to be displayed via a display, for example the status of a processing station, loading station, or unloading station. If corresponding sensors are provided, the status of any desired functional groups can be detected and graphically depicted in a manner associated with the respective functional groups and/or processing stations.

As already mentioned above, the depictions can be called up and concretized by means of a touch sensor by directly touching an overview depiction. The use of a touch panel is in any event advantageous, and simplifies handling.

Lastly, in the event the defined and continuously recalculated reagent working life data are exceeded, a visual and/or acoustic indication could be provided. The data obtained in the context of monitoring could, in additionally advantageous fashion, serve to initiate or control an automatic refilling or automatic replacement of the reagents.

The single Figure shows an exemplary embodiment of a graphical display, the reagent status being depicted in the form of vertical bars. The individual processing stations are displayed and serially numbered thereon. Different kinds of depictions are possible in light of the teaching claimed.

What is claimed is:

1. In a method for treating cytological or histological specimens in an automatic stainer, the specimens being delivered on object carriers and in object carrier magazines by means of a transport device to various processing stations containing reagents, inserted therein, and treated in accordance with a selectable treatment program, the improvement comprising the steps of:
automatically monitoring said reagents of said processing stations, and taking into consideration definable parameters in said monitoring.

2. The improvement as defined in claim 1, wherein the type of reagent contained in a processing station is defined as a parameter and allocated to the respective processing station.

3. The improvement as defined in claim 1, wherein a working life limit of the reagent contained in a processing station is defined as a parameter and allocated to the respective processing station.

4. The improvement as defined in claim 3, wherein for definition of said working life limit, an upper limit value and a warning threshold value are defined as parameters and allocated to said respective processing station.

5. The improvement as defined in claim 3, wherein said working life limit is selected from a predefined library that can be added to.

6. The improvement as defined in claim 3, wherein an absolute working life of the reagent contained in a processing station in terms of days since the last reagent change is defined as a parameter and allocated to the respective processing station.

7. The improvement as defined in claim 6, wherein after a change of reagents, the number of working processes that have taken place in the respective processing station is counted, and from that said working life is calculated.

8. The improvement as defined in claim 1, wherein said step of monitoring comprises monitoring the physical composition and fill level of the reagent contained in a respective processing station.

9. The improvement as defined in claim 1, further comprising the step of displaying said definable parameters and data detected from said monitoring.

10. The improvement as defined in claim 9, wherein data calculated from said monitoring are also displayed.

11. The improvement according to claim 9, wherein said definable parameters and data detected from said monitoring are graphically displayed.

12. The improvement according to claim 11, wherein said processing stations are represented by corresponding symbols in an overview graphical depiction.

13. The improvement as defined in claim 12, wherein said symbols are arranged in said graphical depiction in a manner analogous to the actual physical arrangement of said processing stations.

14. The improvement as defined in claim 12, wherein a working life limit of a reagent contained in a processing station is one of said definable parameters, and said working life limit is displayed in an analog representation linked with a corresponding processing station symbol in said overview graphical depiction.

15. The improvement as defined in claim 14, wherein said analog representation is a bar graph.

16. The improvement as defined in claim 11, wherein the fill level of a reagent contained in a processing station is monitored, and said fill level is displayed in an analog representation linked with a corresponding processing station symbol in said overview graphical depiction.

17. The improvement as defined in claim 16, wherein said analog representation is a bar graph.

18. The improvement as defined in claim 9, wherein further parameters and data relevant to processing are displayed.

19. The improvement as defined in claim 18, wherein said further parameters and data include the loading status of a processing station.

20. The improvement as defined in claim 12, wherein said definable parameters and data detected from said monitoring are graphically displayed for a specific processing station by directly touching a corresponding processing station symbol in said overview graphical depiction.

21. The improvement as defined in claim 3, further comprising the step of providing an indication when said working life limit of said reagent at a processing station is exceeded.

22. The improvement as defined in claim 21, wherein said indication includes a visual indication.

23. The improvement as defined in claim 21, wherein said indication includes an acoustic indication.

24. The improvement as defined in claim 8, further comprising the step of automatically refilling said processing stations with reagents based on data obtained through said step of monitoring.
